(19) United States
(12) Patent Application Publication
(10) Pub. No.: US 2024/0087794 A1
(43) Pub. Date: Mar. 14, 2024

(54) INDUCTOR, SINGULATED INDUCTOR, AND METHOD FOR PRODUCING SINGULATED INDUCTOR

(71) Applicant: NITTO DENKO CORPORATION, Osaka (JP)

(72) Inventors: Yoshihiro FURUKAWA, Osaka (JP); Keisuke OKUMURA, Osaka (JP)

(73) Assignee: NITTO DENKO CORPORATION, Osaka (JP)

(21) Appl. No.: 18/264,208

(22) PCT Filed: Feb. 3, 2022
(86) PCT No.: PCT/JP2022/004314

§ 371 Date: Aug. 3, 2023

(30) Foreign Application Priority Data
Feb. 4, 2021 (JP) 2021-016897

(51) Int. Cl. H01F 27/28; H01F 17/04; H01F 41/00

(52) U.S. Cl. CPC H01F 27/2823; H01F 17/04; H01F 41/00

(57) ABSTRACT

An inductor including a magnetic layer, and a plurality of wires embedded in the magnetic layer and extending in a longitudinal direction. The plurality of wires are spaced in parallel at predetermined intervals in a direction perpendicular to the longitudinal direction. The magnetic layer includes a plurality of wire disposed portions in which the wires are regularly disposed in parallel to each other, and a margin portion that is disposed between the wire disposed portions adjacent to each other in a parallel direction of the wires and in which the wires are omitted.

### TECHNICAL FIELD

The present invention relates to an inductor, a singulated inductor, and a method for producing the singulated inductor.

### BACKGROUND ART

There has been known an inductor including a magnetic layer, and a plurality of wires embedded in the magnetic layer (see, for example, Patent Document 1 below). In the inductor disclosed in Patent Document 1, the plurality of wires are disposed in parallel at equal intervals in the lateral direction. The magnetic layer contains magnetic particles.

### CITATION LIST

Patent Document
Patent Document 1: Japanese Unexamined Patent Publication No. 2020-150057

### SUMMARY OF THE INVENTION

### Problem to be Solved by the Invention

Depending on the use and purpose, a singulated inductor having a size smaller than the inductor may be produced by cutting the magnetic layer between adjacent wires in the thickness direction.

In the inductor disclosed in Patent Document 1, in the case of a short interval between two wires adjacent to each other, when the magnetic layer between the two adjacent wires is cut, the distance from one side end face of the magnetic layer to the end wire disposed in one end in the lateral direction in the singulated inductor thus cut becomes extremely short.

This causes the amount of the magnetic particles existing between the one side end face and the end wire in the magnetic layer to excessively decrease. For this reason, the inductance of the singulated inductor is disadvantageously reduced.

On the other hand, in the case of a long interval between two wires adjacent to each other, the singulated inductor thus cut cannot be miniaturized.

The present invention provides a singulated inductor designed to suppresses a reduction in inductance and to achieve miniaturization, a method for producing the singulated inductor, and an inductor used in the method.

### Means for Solving the Problem

The present invention (1) includes an inductor including a magnetic layer; and a plurality of wires embedded in the magnetic layer and extending in a longitudinal direction, the plurality of wires being spaced in parallel at predetermined intervals in a direction perpendicular to the longitudinal direction, in which the magnetic layer includes a plurality of wire disposed portions in which the wires are regularly disposed in parallel to each other; and a margin portion that is disposed between the wire disposed portions adjacent to each other in a parallel direction of the wires and in which the wires are omitted.

In this inductor, the wires are omitted in the margin portion of the magnetic layer. Therefore, by cutting the margin portion along the longitudinal direction, a distance between the cut side end face of the magnetic layer and a wire adjacent to the cut side end face can be sufficiently secured. For this reason, the amount of a magnetic component existing between the cut side end face and the wire is sufficient in the magnetic layer. As a result, the reduction in inductance of the singulated inductor thus cut can be suppressed.

Meanwhile, in the wire disposed portion, the wires are regularly disposed in parallel to each other. This allows the wires to be compactly disposed in the singulated inductor. As a result, the singulated inductor thus cut can be miniaturized.

Therefore, this inductor can suppress the reduction in inductance of the singulated inductor thus cut and can achieve miniaturization of the singulated inductor.

The present invention (2) includes the inductor described in (1), in which the plurality of wires are disposed in parallel at equal intervals in the wire disposed portion.

In the wire disposed portion of the inductor, the plurality of wires are disposed in parallel at equal intervals. Therefore, the wires can be more compactly disposed in the wire disposed portion. Further, the inductance of each wire can be equalized. As a result, while the singulated inductor thus cut can be further miniaturized, the inductance of each wire can be equalized.

The present invention (3) includes a method for producing a singulated inductor, the method including a first step of preparing the inductor described in (1) or (2); and a second step of cutting the margin portion.

Since in the method for producing a singulated inductor, the margin portion is cut, the distance between a cut side end face of the magnetic layer and the wire adjacent to the cut side end face can be sufficiently secured. For this reason, the amount of the magnetic component existing between the cut side end face and the wire is sufficient in the magnetic layer. As a result, the reduction in inductance of the singulated inductor after the second step can be suppressed.

Meanwhile, in the wire disposed portion, the wires are regularly disposed in parallel to each other. This allows the wires to be compactly disposed in the singulated inductor. As a result, the singulated inductor after the second step can be miniaturized.

Therefore, in this method for producing a singulated inductor, a singulated inductor designed to suppress a reduction in inductance and to achieve miniaturization can be produced.

The present invention (4) includes a singulated inductor including a magnetic layer; and a plurality of wires embedded in the magnetic layer and extending in a longitudinal direction, the plurality of wires being spaced in parallel at predetermined intervals in a direction perpendicular to the longitudinal direction, in which the magnetic layer includes a wire disposed portion in which the wires are regularly disposed in parallel to each other, the wires include an end wire disposed in one end of the wire disposed portion in the parallel direction of the wires, and a distance from one side end face of the magnetic layer to the end wire in a parallel direction is 0.2 mm or more and 7 mm or less.

Since in this singulated inductor, the distance from one side end face of the magnetic layer to the end wire is 0.2 mm or more, the amount of the magnetic component existing between the cut side end face and the end wire is sufficient in the magnetic layer. As a result, the reduction in inductance of the singulated inductor can be suppressed.

Further, since in this singulated inductor, the distance from one side end face of the magnetic layer to the end wire is 7 mm or less, the singulated inductor achieves miniaturization.

Therefore, this singulated inductor achieves miniaturization while suppressing the reduction in inductance.

The present invention (5) includes the singulated inductor described in (4), in which an end face of the wire in the longitudinal direction has an exposed portion that is exposed from the magnetic layer.

The present invention (6) includes the singulated inductor described in (4) or (5), in which an end face of the wire in the longitudinal direction has a covered portion that is covered with the magnetic layer.

The present invention (7) includes the singulated inductor described in any one of (4) to (6), having a rectangular shape including a curved corner in plan view.

The present invention (8) includes the singulated inductor described in (7), in which the curve is a curved line having a radius of curvature of 0.1 mm or more and 5 mm or less.

When the radius of curvature of the curved line is 0.1 mm or more as described above, the inductor can have improved impact resistance.

When the radius of curvature of the curved line is 5 mm or less as described above, an area near the corner can be widened, and a mark can be placed in an open space.

### Effects of the Invention

The method for producing a singulated inductor according to the present invention using the inductor of the present invention can produce a singulated inductor designed to suppress a reduction in inductance and to achieve miniaturization.

The singulated inductor of the present invention is designed to suppress the reduction in inductance and to achieve miniaturization.

### BRIEF DESCRIPTION OF THE DRAWINGS

FIGS. 1A and 1B are plan views of an inductor and a singulated inductor, respectively, according to the present invention: FIG. 1A shows the inductor, and FIG. 1B shows a plurality of singulated inductors.

FIGS. 2A and 2B are cross-sectional views corresponding to FIGS. 1A and 1B, respectively: FIG. 2A shows the inductor, and FIG. 2B shows the plurality of singulated inductors.

FIGS. 3A and 3B are cross-sectional views of variations of the inductor and the singulated inductor, respectively: FIG. 3A shows the inductor, and FIG. 3B shows the plurality of singulated inductors.

FIGS. 4A and 4B are cross-sectional views of variations of the inductor and the singulated inductor, respectively: FIG. 4A shows the inductor, and FIG. 4B shows the plurality of singulated inductors.

FIGS. 5A and 5B are plan views of variations of the inductor and the singulated inductor, respectively: FIG. 5A shows the inductor, and FIG. 5B shows a second singulated inductor.

FIG. 6 is a front view of an end face of the singulated inductor in the longitudinal direction according to the variation.

### DESCRIPTION OF THE EMBODIMENTS

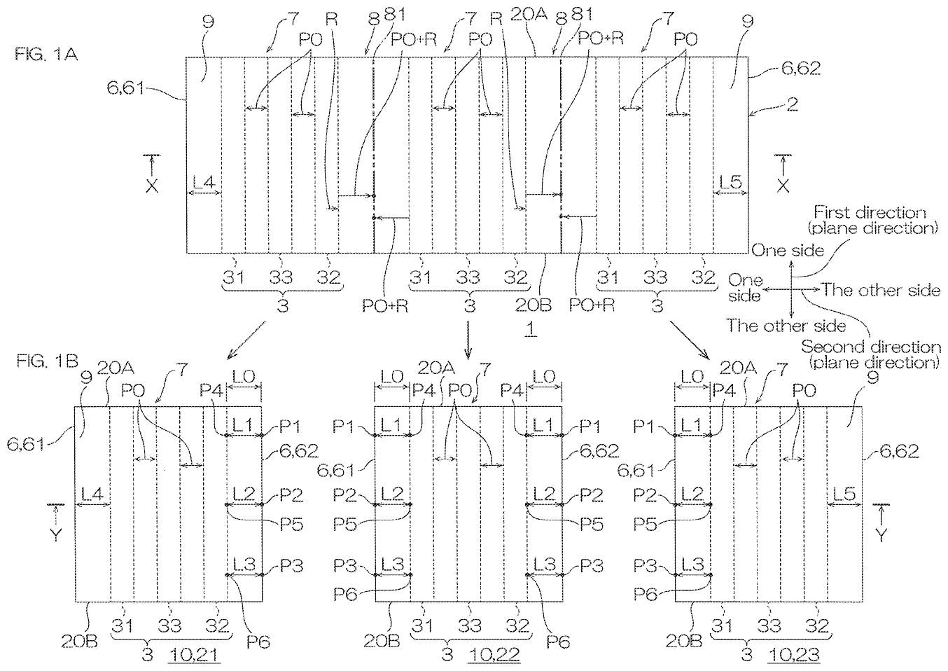

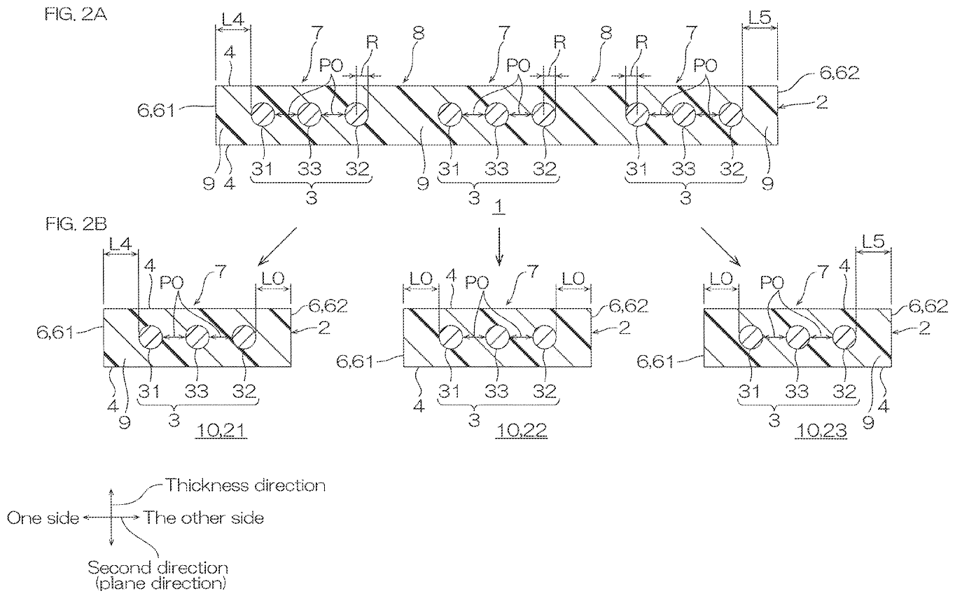

One embodiment of an inductor and a singulated inductor according to the present invention will be described with reference to FIGS. 1A to 2B.

### <Inductor 1>

As shown in FIGS. 1A and 2A, the inductor 1 extends in a plane direction perpendicular to a thickness direction. The thickness direction is a depth direction on the paper plane of FIG. 1A. The thickness direction is an up-down direction in FIG. 2A. The plane direction includes a first direction and a second direction that is perpendicular to the first direction. The first direction is an up-down direction in FIG. 1A. The first direction is a depth direction on the paper plane of FIG. 2A. The second direction is a right-left direction in each of FIGS. 1A and 2A. The inductor 1 is a sheet having a generally rectangular shape in plan view. The inductor 1 includes a magnetic layer 2, and a plurality of wires 3.

### <Magnetic Layer 2>

The magnetic layer 2 has the same outer shape as the inductor 1. The magnetic layer 2 continuously has two principal surfaces 4 facing to each other in the thickness direction, two first side end faces 20A, 20B (see FIG. 1A) facing to each other in the first direction, and two second side end faces 6 facing to each other in the second direction. The first side end faces 20A, 20B (see FIG. 1A) are along the second direction. The second side end faces 6 are along the first direction. The two second side end faces 6 include one second side end face 61 disposed on one side in the second direction, and the other second side end face 62 disposed on the other side in the second direction. Examples of a material of the magnetic layer 2 include a magnetic composition containing magnetic particles as a magnetic component. The magnetic composition is described in Japanese Unexamined Patent Publication No. 2020-150057. The magnetic layer 2 has a thickness of, for example, 1 μm or more and for example, 5000 μm or less. The thickness of the magnetic layer 2 is a distance between the two principal surfaces 4. This magnetic layer 2 includes a wire disposed portion 7 to be described later, a margin portion 8 to be described later, and a second margin portion 9 to be described later.

### <Wire 3>

The wire 3 extends along the first direction. The first direction corresponds to a longitudinal direction of the wire 3. The plurality of wires 3 are disposed in parallel at predetermined intervals in a cross section along the thickness direction and the second direction. The cross section along the thickness direction and the second direction is a cross section illustrated in FIG. 2A. Therefore, the second direction corresponds to a parallel direction in which the wires 3 are in parallel. The wires 3 are embedded in the magnetic layer 2. The configurations and sizes of the plurality of wires 3 are described in, for example, Japanese Unexamined Patent Publication No. 2020-150057. The wires 3 have a radius R of, for example, 25 μm or more and for example, 2000 μm or less. Next, the wire disposed portion 7 and the margin portion 8 are described.

### <Wire Disposed Portion 7>

A plurality of (three in the present embodiment) wire disposed portions 7 are included in the magnetic layer 2. The plurality of wire disposed portions 7 are spaced apart from each other in the second direction. Each of the plurality of wire disposed portions 7 is disposed over the first direction in the inductor 1. The wires 3 are regularly disposed in parallel to each other in the wire disposed portion 7. Specifically, the plurality of (three in the present embodiment) wires 3 are disposed in parallel at equal intervals P0 in the wire disposed portion 7. The size of the wires 3 and the interval P0 of two adjacent wires 3 are not limited. These are described in, for example, Japanese Unexamined Patent Publication No. 2020-150057.

The plurality of wires 3 are disposed in the wire disposed portion 7. The plurality of wires 3 include a first end wire 31, a second end wire 32, and an intermediate wire 33. The first end wire 31 is disposed in one end in the second direction of the wire disposed portion 7. The second end wire 32 is disposed in the other end in the second direction of the wire disposed portion 7. The intermediate wire 33 is disposed between the first end wire 31 and the second end wire 32. Therefore, the first end wire 31, the intermediate wire 33, and the second end wire 32 are disposed in order toward the other side in the second direction in the wire disposed portion 7.

### <Margin Portion 8>

The margin portion 8 is disposed between adjacent wire disposed portions 7. Specifically, the margin portion 8 connects two adjacent wire disposed portions 7 in the second direction. A plurality of (two in the present embodiment) margin portions 8 are included in the magnetic layer 2. The number of wire disposed portions 7 is one more than the number of margin portions 8. The plurality of margin portions 8 are disposed over the first direction in the inductor 1.

The wires 3 are omitted in the margin portion 8. In detail, in the inductor 1 in which all the wires 3 are disposed in parallel at equal intervals P0 in the second direction, one wire 3 is removed (omitted) for every predetermined number of (four in the present embodiment) wires 3. Then, the area (and its vicinity) where the wires 3 are removed (omitted) in the magnetic layer 2 is the margin portion 8, and the area other than the margin portion 8 in the magnetic layer 2 is the wire disposed portion 7.

In the margin portion 8, the wires 3 are not disposed but only the magnetic layer 2 is disposed. Further, the margin portion 8 has a length in the second direction such that a distance L0 to be described later is secured.

<Second margin portion 9>

The second margin portion 9 is disposed outside the outermost wire disposed portion 7 in the second direction. That is, the second margin portion 9 is disposed on both ends of the inductor 1 in the second direction. Specifically, the second margin portion 9 is disposed on one side of the wire disposed portion 7 located on one endmost side in the second direction and on the other side of the wire disposed portion 7 located on the other endmost side in the second direction. In the present embodiment, the number of the second margin portions 9 is two. In the second margin portion 9, the wire 3 is not disposed but only the magnetic layer 2 is disposed.

### <Method for Producing Singulated Inductor 10>

Next, a method for producing the singulated inductor 10 using the inductor 1 is described. This producing method includes a first step and a second step.

### <First Step>

In the first step, the inductor 1 shown in FIGS. 1A and 2A is prepared. A method of preparing the inductor 1 is not limited. The method of preparing the inductor 1 is described in, for example, Japanese Unexamined Patent Publication No. 2020-150057.

### <Second Step>

In the second step, the margin portion 8 is cut. Specifically, a generally central portion 81 of the margin portion 8 in the second direction is cut along the first direction. In detail, the generally central portion 81 in the second direction between the second end wire 32 and the first end wire 31 that is opposed to the second end wire 32 in the second direction is cut in the magnetic layer 2. More specifically, the magnetic layer 2 is cut so as to pass through a point moved forward from the second end wire 32 to the other side in the second direction by a total length (P0+R) of a length equal to the interval P0 between the wires 3 described above and the radius R of the wire 3. Also, the magnetic layer 2 is cut so as to pass through a point moved forward from the first end wire 31 to one side in the second direction by the total length (P0+R) of the length equal to the interval P0 between the wires 3 described above and the radius R of the wire 3.

Examples of the cutting of the margin portion 8 include non-contact cutting processes such as laser cutting. Examples of the cutting of the margin portion 8 include contact cutting processes such as punching with a die and dicing with a rotary cutter. Preferably, a contact cutting process is used from the viewpoint of shortening the time for the second step, more preferably, punching is used from the viewpoint of improving the quality of the product.

By cutting the above-described margin portion 8, one margin portion 8 is divided into two portions. In the present embodiment, two margin portions 8 are cut to thereby produce three singulated inductors 10.

### <Singulated Inductor 10>

The three singulated inductors 10 include a first singulated inductor 21, a second singulated inductor 22, and a third singulated inductor 23. The first singulated inductor 21 includes the wire disposed portion 7 disposed on one endmost side in the second direction of the inductor 1. The third singulated inductor 23 includes the wire disposed portion 7 disposed on the other endmost side in the second direction of the inductor 1. The second singulated inductor 22 includes the wire disposed portion 7 disposed in the middle of the second direction. The second singulated inductor 22, the first singulated inductor 21, and the third singulated inductor 23 are described in order.

First, the second singulated inductor 22 is described in detail, and then, the first singulated inductor 21 and the third singulated inductor 23 are briefly described. The description of members and the like that are common to the second singulated inductor 22 is omitted in the description of the first singulated inductor 21 and the third singulated inductor 23. Members other than those specified are the same as the members in the inductor 1 described above.

### <Second Singulated Inductor 22>

The second singulated inductor 22 is a sheet having a generally rectangular shape in plan view. The second singulated inductor 22 has a shorter length in the second direction than the inductor 1. The second singulated inductor 22 includes the magnetic layer 2, and the wires 3. The wires 3 are embedded in the magnetic layer 2.

### <Magnetic Layer 2 in Second Singulated Inductor 22>

The magnetic layer 2 in the second singulated inductor 22 has the same outer shape as the second singulated inductor 22. The magnetic layer 2 has two principal surfaces 4, two first side end faces 20A, 20B (see FIG. 1A), and two second side end faces 6. The principal surfaces 4 and the first side end faces 20A, 20B (see FIG. 1A) are the same as those in the inductor 1. The two second side end faces 6 are both cut surfaces (cut side end faces) formed by cutting the margin portions 8. The two second side end faces 6 include the one second side end face 61 and the other second side end face 62. The magnetic layer 2 includes the wire disposed portion 7.

### <Wire Disposed Portion 7 in Second Singulated Inductor 22>

One wire disposed portion 7 is provided in one second singulated inductor 22. The first end wire 31, the second end wire 32, and the intermediate wire 33 are disposed in the wire disposed portion 7.

### <Distance L0 Between One Second Side End Face 61 and First End Wire 31>

In the second direction, the distance L0 from the one second side end face 61 of the magnetic layer 2 to the first end wire 31 is 0.2 mm or more and 7 mm or less. When the distance L0 is less than 0.2 mm, the amount of the magnetic particles existing between the one second side end face 61 and the first end wire 31 in the magnetic layer 2 is excessively decreased, so that a reduction in inductance of the second singulated inductor 22 cannot be suppressed. When the distance L0 exceeds 7 mm, the second singulated inductor 22 cannot be miniaturized. The distance L0 is preferably 0.4 mm or more, and preferably 5 mm or less.

### <Distance L0 Between the Other Second Side End Face 62 and Second End Wire 32>

In the second direction, the distance L0 from the other second side end face 62 of the magnetic layer 2 to the second end wire 32 is 0.2 mm or more and 7 mm or less. When the distance L0 is less than 2 mm, the amount of the magnetic particles existing between the other second side end face 62 and the second end wire 32 in the magnetic layer 2 is excessively decreased, so that a reduction in inductance of the second singulated inductor 22 cannot be suppressed. When the distance L0 exceeds 7 mm, the second singulated inductor 22 cannot be miniaturized. The distance L0 is preferably 0.4 mm or more, and preferably 5 mm or less.

Of respective distances L1, L2, and L3 from a first point P1, a second point P2, and a third point P3 that are spaced apart from each other in the first direction in the other second side end face 62 of the magnetic layer 2 to a fourth point P4, a fifth point P5, and a sixth point P6 (none of which are shown) that are adjacent to the first point P1, the second point P2, and the third point P3, respectively, in the second direction in the second end wire 32, a difference between the maximum value and the minimum value is, for example, 2 mm or less, preferably 1 mm or less. When the above-described difference is less than the upper limit, dispersion in the inductance of the second singulated inductor 22 in the first direction can be reduced.

### <First Singulated Inductor 21>

The first singulated inductor 21 includes the magnetic layer 2, and the wires 3. The magnetic layer 2 has two principal surfaces 4, two first side end faces 20A, 20B (see FIG. 1A), and two second side end faces 6. The principal surfaces 4, the first side end faces 20A, 20B (see FIG. 1A), and the one second side end face 61 are the same as those in the inductor 1. The other second side end face 62 is a cut surface (cut side end face) formed by cutting the margin portion 8. The magnetic layer 2 includes the wire disposed portion 7. The distance L0 from the other second side end face 62 to the second end wire 32 is the same as described above. A distance L4 from the one second side end face 61 to the first end wire 31 is the same as the above-described distance L0. The distance L4 in the second singulated inductor 22 shown in FIGS. 1B and 2B and the distance L4 in the inductor 1 shown in FIGS. 1A and 2A are the same. The distance L4 is also the width of the second margin portion 9.

### <Third Singulated Inductor 23>

The third singulated inductor 23 includes the magnetic layer 2, and the wires 3. The magnetic layer 2 has two principal surfaces 4, two first side end faces 20A, 20B (see FIG. 1A), and two second side end faces 6. The principal surfaces 4, the first side end faces 20A, 20B (see FIG. 1A), and the other second side end face 62 are the same as those in the inductor 1. The one second side end face 61 is a cut surface (cut side end face) formed by cutting the margin portion 8. The magnetic layer 2 includes the wire disposed portion 7. The distance L0 from the one second side end face 61 to the first end wire 31 is the same as described above. A distance L5 from the other second side end face 62 to the second end wire 32 is the same as the above-described distance L0. The distance L5 in the third singulated inductor 23 shown in FIGS. 1B and 2B and the distance L5 in the inductor 1 shown in FIGS. 1A and 2A are the same. The distance L5 is also the width of the second margin portion 9.

### Operations and Effects of Embodiment

In this inductor 1, the wires 3 are omitted in the margin portion 8 of the magnetic layer 2. Therefore, by cutting the margin portion 8 along the first direction, the distance L0 between the one second side end face 61 of the magnetic layer 2 and the first end wire 31 each in the second singulated inductor 22 and the third singulated inductor 23 can be sufficiently secured. For this reason, the amount of the magnetic particles existing between the one second side end face 61 and the first end wire 31 is sufficient in the magnetic layer 2. Also, the distance L0 between the other second side end face 62 of the magnetic layer 2 and the second end wire 32 each in the second singulated inductor 22 and the first singulated inductor 21 can be sufficiently secured. For this reason, the amount of the magnetic particles existing between the other second side end face 62 and the second end wire 32 is sufficient in the magnetic layer 2. As a result, the reduction in inductance of the singulated inductors 10 thus cut (first singulated inductor 21, second singulated inductor 22, third singulated inductor 23) can be suppressed.

Meanwhile, in the wire disposed portion 7, the wires 3 are regularly disposed in parallel to each other. This allows the wires 3 to be compactly disposed in the wire disposed portions 7. As a result, the singulated inductors 10 thus cut can be miniaturized.

Therefore, in this inductor 1, the reduction in inductance of the singulated inductors 10 thus cut can be suppressed, and the singulated inductors 10 can be miniaturized.

In the method for producing the singulated inductor 10, the margin portion 8 is cut. Therefore, the distance L0 between the one second side end face 61 of the magnetic layer 2 and the first end wire 31 each in the second singulated inductor 22 and the third singulated inductor 23 can be sufficiently secured. The distance L0 between the other second side end face 62 of the magnetic layer 2 and the second end wire 32 each in the second singulated inductor 22 and the first singulated inductor 21 can be sufficiently secured. Thus, the reduction in inductance of the singulated inductor 10 after the second step can be suppressed.

Meanwhile, in the wire disposed portion 7, the wires 3 are regularly disposed in parallel to each other. This allows the wires 3 to be compactly disposed in the singulated inductor 10. As a result, the singulated inductor 10 after the second step can be miniaturized.

Therefore, in this method for producing the singulated inductor 10, the singulated inductor 10 designed to suppress the reduction in inductance and to achieve miniaturization can be produced.

In the second singulated inductor 22, since the distance L0 from the one second side end face 61 to the first end wire 31 and the distance L0 from the other second side end face 62 to the second end wire 32 are 0.2 mm or more, the amounts of the magnetic particles existing between the one second side end face 61 and the first end wire 31 and the magnetic particles existing between the other second side end face 62 and the second end wire 32 are sufficient. Thus, the reduction in inductance of the second singulated inductor 22 can be suppressed.

Further, since the above-described distances L0 exceed 7 mm, the second singulated inductor 22 can be miniaturized.

Therefore, the second singulated inductor 22 can be miniaturized while suppressing the reduction in inductance.

The first singulated inductor 21 and the third singulated inductor 23 can also achieve the same operations and effects as the second singulated inductor 22.

### <Variations>

In the following variations, the same reference numerals are provided for members and steps corresponding to each of those in one embodiment described above, and their detailed description is omitted. Further, the variations can achieve the same operations and effects as those of the embodiment unless especially described otherwise. Furthermore, the embodiment and variations thereof can be appropriately used in combination.

In the embodiment, there is a single intermediate wire 33. In the variations, there are a plurality of intermediate wires 33. In one wire disposed portion 7, the plurality of intermediate wires 33 are disposed in parallel at equal intervals P0 in the second direction.

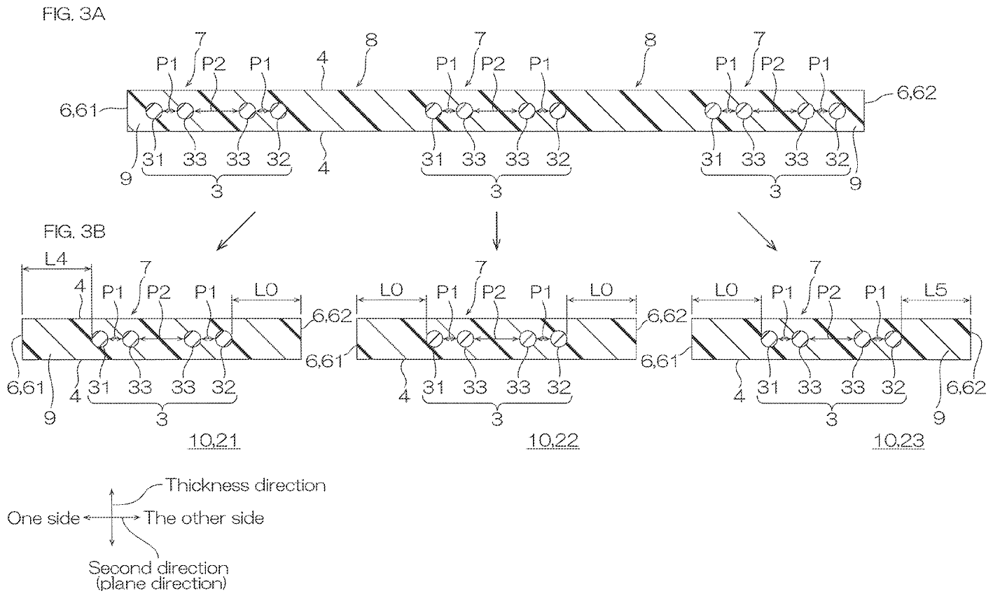

As shown in FIG. 3A, in the wire disposed portion 7 of the inductor 1 of the variation, the plurality of wires 3 are spaced apart from each other not at equal intervals P0 but at a first interval P1 and a second interval P2 longer than the first interval P1. That is, the plurality of wires 3 are disposed at different intervals P1 and P2 from each other in one wire disposed portion 7. The first interval P1 and the second interval P2 are alternately arranged in the second direction. Meanwhile, the second interval P2 is shorter than the length in the second direction of the margin portion 8, for example.

The embodiment is more suitable than the variation. In the wire disposed portions 7 of the inductor 1 of the embodiment, the plurality of wires 3 are disposed in parallel at equal intervals P0. Therefore, the wires 3 can be more compactly disposed in the wire disposed portion 7. Further, the inductance of each wire 3 can be equalized. As a result, while the singulated inductor 10 can be further miniaturized, the inductance of each wire 3 can be equalized.

Though not shown, the number of margin portions 8 in the inductor 1 may be one.

Though not shown, a plurality of second singulated inductors 22 can also be produced by cutting one inductor 1. In this case, the inductor 1 includes four or more wire disposed portions 7 and three or more margin portions 8. By cutting three or more margin portions 8, two or more second singulated inductors 22 are produced.

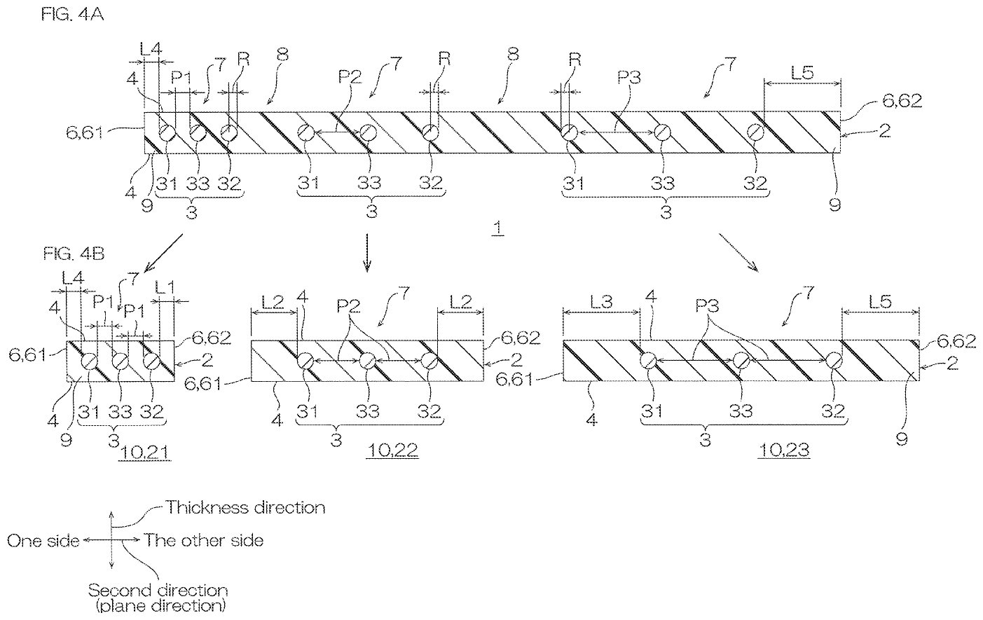

In the variation shown in FIG. 4B, the intervals P1, P2, and P3 between wires in the plurality of singulated inductors 10 are different from each other. Specifically, the first interval P1 between adjacent wires 3 in the first singulated inductor 21, the second interval P2 between adjacent wires 3 in the second singulated inductor 22, and the third interval P3 between adjacent wires 3 in the third singulated inductor 23 are different from each other.

In the first singulated inductor 21, the plurality of wires 3 are disposed in parallel at equal intervals P1. In the first singulated inductor 21, the distance L1 between the other second side end face 62 and the second end wire 32 is 0.2 mm or more and 7 mm or less, and is the same as, for example, the above-described first interval P1. Also, the distance L1 between the other second side end face 62 and the second end wire 32 is the same as the distance L4 from the one second side end face 61 to the first end wire 31.

In the second singulated inductor 22, the plurality of wires 3 are disposed in parallel at equal intervals P2. In the second singulated inductor 22, the distance L2 between the other second side end face 62 and the second end wire 32 is 0.2 mm or more and 7 mm or less, and is the same as, for example, the above-described second interval P2. Also, the distance L2 between the other second side end face 62 and the second end wire 32 is the same as the distance L2 from the one second side end face 61 to the first end wire 31.

In the third singulated inductor 23, the plurality of wires 3 are disposed in parallel at equal intervals P3. In the third singulated inductor 23, the distance L3 from the one second side end face 61 to the first end wire 31 is 0.2 mm or more and 7 mm or less, and is the same as, for example, the above-described third interval P3. Also, the distance L3 between the one second side end face 61 and the first end wire 31 is the same as the distance L5 between the other second side end face 62 and the second end wire 32.

As shown in FIG. 4A, the inductor 1 prepared in the first step includes the wire disposed portion 7 corresponding to the first singulated inductor 21, the wire disposed portion 7 corresponding to the second singulated inductor 22, and the wire disposed portion 7 corresponding to the third singulated inductor 23 that are spaced apart from the margin portions 8.

In the second step, a middle portion between the second end wire 32 and the first end wire 31 that is opposed to the second end wire 32 in the second direction is cut in the magnetic layer 2. More specifically, the magnetic layer 2 is cut so as to pass through a point moved forward from the second end wire 32 to the other side in the second direction by the total length of the length equal to the first interval P1 or the second interval P2 and the radius R of the wire 3. Alternatively, the magnetic layer 2 is cut so as to pass through a point moved forward from the first end wire 31 to one side in the second direction by the total length of the length equal to the second interval P2 or the third interval P3 and the radius R of the wire 3.

In the second step, the margin portion 8 is cut, and the magnetic layer 2 and the plurality of wires 3 are cut along the second direction (parallel direction). For example, the inductor 1 is cut into a rectangular shape in plan view. This gives a singulated inductor 10 having a rectangular shape in plan view.

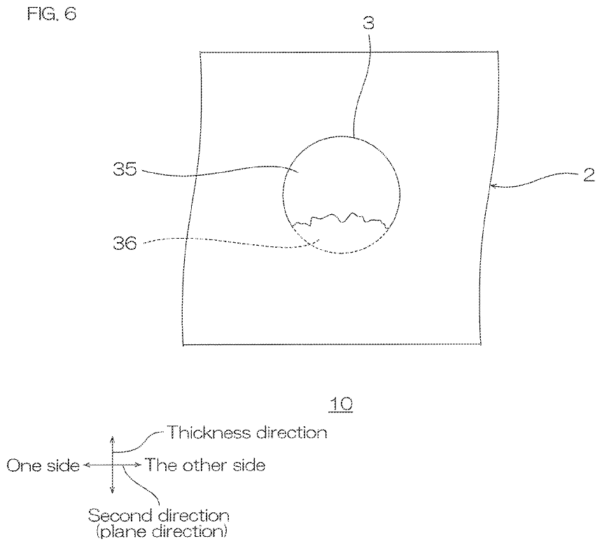

In this variation, as shown in FIG. 6, for example, the end face (first side end face/second side end face) of the wire 3 in the longitudinal direction includes an exposed portion 35 and a covered portion 36. The exposed portion 35 is a portion exposed from the magnetic layer 2 in the end face of the wire 3. The covered portion 36 is a portion covered with the magnetic layer 2 (adhered substance during cutting) in the end face of the wire 3.

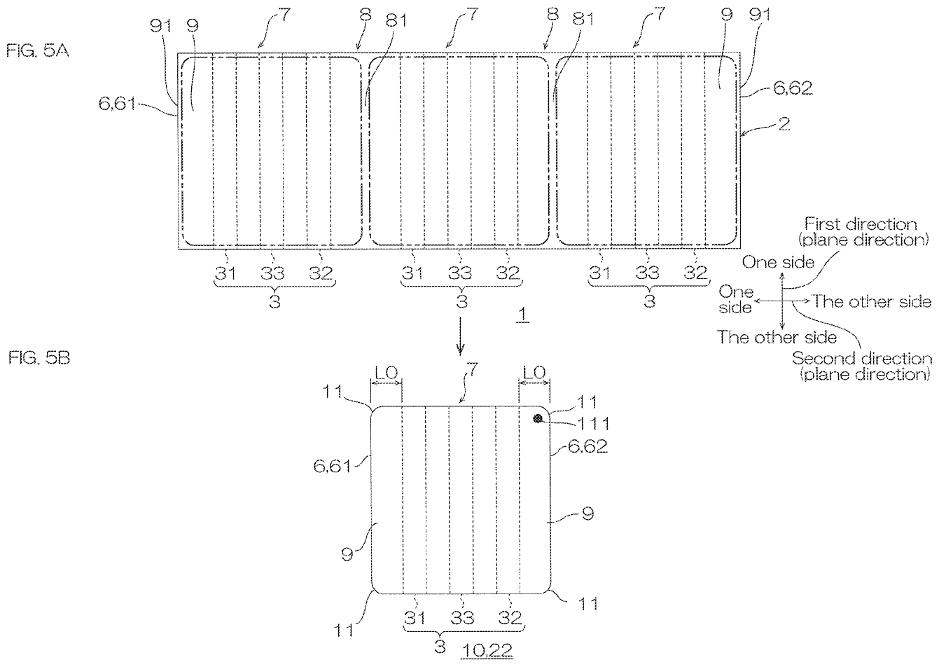

To obtain the singulated inductor 10 of this variation, the inductor 1 shown in FIG. 5A is cut along each of the first and second directions. For cutting, preferably, punching and dicing are used. For punching, a die having four curved corners (curved lines) is used.

The magnetic layer 2 and the wires 3 in the inductor 1 are cut so that one ends and the other ends thereof in the first direction remain.

The magnetic layer 2 is cut so that the central portion 81 of the margin portion 8 in the second direction remain.

The margin portion 8 is cut, and the second margin portion 9 is cut. The margin portion 9 is cut along the first direction. In this manner, an outer end of the second margin portion 9 in the second direction remains.

The singulated inductor 10 thus obtained above has, for example, a generally rectangular shape in plan view in which four corners 11 each have a curve (curved line). The corner 11 has a radius of curvature of, for example, 0.1 mm or more, preferably 0.2 mm or more. The corner 11 has a radius of curvature of, for example, 5 mm or less, preferably 4 mm or less.

When the radius of curvature of the corner 11 is more than the above-described lower limit, the inductor 1 can have improved impact resistance.

When the radius of curvature of the corner 11 is less than the upper limit, an area near the corner 11 can be widened, and a mark (including an alignment mark 111) can be placed in the widened open space.

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The inductor is used as an electronic component in an electric circuit.

### DESCRIPTION OF REFERENCE NUMERALS

1 inductor
2 magnetic layer
3 wire
7 wire disposed portion
8 margin portion
10 singulated inductor
11 corner
21 first singulated inductor
22 second singulated inductor
23 third singulated inductor
35 exposed portion
36 covered portion
L0 distance
L1 distance
L2 distance
L3 distance
P0 equal interval

1. An inductor comprising:
a magnetic layer; and
a plurality of wires embedded in the magnetic layer and extending in a longitudinal direction, the plurality of wires being spaced in parallel at predetermined intervals in a direction perpendicular to the longitudinal direction,
wherein the magnetic layer includes
a plurality of wire disposed portions in which the wires are regularly disposed in parallel to each other; and
a margin portion that is disposed between the wire disposed portions adjacent to each other in a parallel direction of the wires and in which the wires are omitted.

2. The inductor according to claim 1, wherein the plurality of wires are disposed in parallel at equal intervals in the wire disposed portion.

3. A method for producing a singulated inductor, the method comprising:
a first step of preparing the inductor according to claim 1; and
a second step of cutting the margin portion.

4. A singulated inductor comprising:
a magnetic layer; and
a plurality of wires embedded in the magnetic layer and extending in a longitudinal direction, the plurality of wires being spaced in parallel at predetermined intervals in a direction perpendicular to the longitudinal direction,
wherein the magnetic layer includes a wire disposed portion in which the wires are regularly disposed in parallel to each other,
the wires include an end wire disposed in one end of the wire disposed portion in a parallel direction of the wires, and
a distance from one side end face of the magnetic layer to the end wire in the parallel direction is 0.2 mm or more and 7 mm or less.

5. The singulated inductor according to claim 4, wherein an end face of the wire in the longitudinal direction has an exposed portion that is exposed from the magnetic layer.

6. The singulated inductor according to claim 4, wherein an end face of the wire in the longitudinal direction has a covered portion that is covered with the magnetic layer.

7. The singulated inductor according to claim 4, having a rectangular shape comprising a curved corner in plan view.

8. The singulated inductor according to claim 7, wherein the curve is a curved line having a radius of curvature of 0.1 mm or more and 5 mm or less.
